(19) United States
(12) Patent Application Publication
(10) Pub. No.: US 2020/0128799 A1
(43) Pub. Date: Apr. 30, 2020

(54) AQUACULTURE BALLAST ANCHOR, MOORING AND CONTROL SYSTEMS

(71) Applicant: 2526357 Ontario Limited, Wheatley (CA)

(72) Inventor: Manny Resendes, Wheatley (CA)

(21) Appl. No.: 16/668,372

(22) Filed: Oct. 30, 2019

Related U.S. Application Data
(60) Provisional application No. 62/752,709, filed on Oct. 30, 2018.

(51) Int. Cl. A01K 61/65; B63B 35/44

(52) U.S. Cl. CPC A01K 61/65; B63B 35/44

(57) ABSTRACT

An aquaculture system including a negatively buoyant enclosure disposed within a body of water. A mooring line can extend between a first anchor and a second anchor coupled to a bottom surface of the body of water, respectively. Two buoys can be disposed within the body of water and on opposing sides of the enclosure and the mooring line can extend from a first buoy and a second buoy and back to the bottom surface of the body of water. The mooring line can be coupled to a bottom surface of the enclosure between the first buoy and the second buoy.

### CROSS-REFERENCE TO RELATED APPLICATIONS

This application claims the benefit of U.S. Provisional Application No. 62/752,709 filed, Oct. 30, 2018, the contents of which are incorporated by reference herein in their entirety.

### FIELD

The present disclosure is broadly concerned with net pen aquaculture. In particular, the present disclosure is related to net pen aquaculture with depth control and positioning of a submersible aquaculture structure.

### BACKGROUND

Aquaculture, specifically fish enclosure systems, often includes net pens, pens, and/or cages used to contain and grow fish within a larger body of water, such as in an ocean or lake environment. Enclosures and related systems can take various physical shapes and different design forms depending on the fish being cultured and the operational environment. Common examples including circular, hexagonal, and octagonal designs. In certain operational environments, enclosures can be submersible, commonly utilizing a spar-based design. The enclosures can be submersible to avoid of risky environmental conditions including adverse weather conditions, wave action, extreme heat temperatures, or ice conditions.

Submersion of these enclosures can require delicate operations by aquaculture operators during these diverse conditions to minimize the risk of harm and/or stress caused to fish, as well as to prevent physical damage to cage systems or loss of cage systems.

Current existing enclosure systems and related anchoring and mooring technologies suffer from a myriad of drawbacks, including lack of control in managing the cage position within the water column, premature wear and tear, risks associated with ice, requires significant on-site operator expertise to ensure safe and proper management.

Present anchoring and mooring technologies contemplate designs to allow the sinking or raising of enclosures as a method to escape weather conditions (example, ice or waves) based on achieving neutral buoyancy to achieve specific placement within the water column, which is impractical and not possible. Current systems often rely on pendulum weights, or node buoys, to regulate depth of submersion. These systems cannot determine accurate neutral buoyancy in the water column with any known consistency. The inability to accurately and repetitively determined neutral buoyancy places fish inventory at risk, as many fish are surface feeders and cannot regulate their air bladders at certain lower depth. The inability also creates opportunity for physical infrastructure damage or risk of loss during failures to successfully sink cage systems due to low control.

Another problem with existing anchoring and mooring design technologies is that current solutions require significant access to open water, due to the attachment points of the mooring lines situated along the surface of the water (shown in FIG. 1). During freezing and/or ice conditions, mooring lines can become at risk of being frozen into the ice, preventing the control of the cage system or ability to perform sinking and/or raising procedures. Lines across the water surface also increase likelihood of collision between operator vessels and cage systems in the open-water.

Existing technologies require significant operator expertise and experience to manage safely, with consistency, due to the complexity of the design and low control fidelity resulting from buoyancy issues. Significant operator expertise is required to perform tasks such as cage lowering or raising procedures, or replacement component procedures, which is not always readily available or practical on a site, highlighting the limitation of the design.

### BRIEF DESCRIPTION OF THE FIGURES

The application file contains at least one photograph executed in color. Copies of this patent application publication with color photographs will be provided by the Office upon request and payment of the necessary fee.

FIG. 1A is a diagrammatic view of an aquaculture anchoring and mooring system, according to existing technologies;

FIG. 1B is a diagrammatic view of a submerged aquaculture anchoring and mooring system, according to existing technologies;

FIG. 1C is a diagrammatic view of a failed submersion aquaculture anchoring and mooring system, according to existing technologies;

FIG. 2 is a diagrammatic view of an aquaculture anchoring and mooring system, according to an exemplary embodiment of the present disclosure;

FIG. 3 is a top view of an aquaculture anchoring and mooring system, according to an exemplary embodiment of the present disclosure;

FIG. 4A is a diagrammatic view of a floating aquaculture anchoring and mooring system, according to an exemplary embodiment of the present disclosure;

FIG. 4B is a diagrammatic view of a submerged aquaculture anchoring and mooring system, according to an exemplary embodiment of the present disclosure;

FIG. 4C is a diagrammatic view of a floating aquaculture anchoring and mooring system with a strong current, according to an exemplary embodiment of the present disclosure;

FIG. 5 is a detailed view of portion AA of FIG. 2;

FIG. 6 is an isometric view of a hub assembly of an aquaculture system, according to an exemplary embodiment of the present disclosure;

FIG. 7 is an exploded isometric view of a hub assembly of an aquaculture system, according to an exemplary embodiment of the present disclosure;

FIG. 8 is a top view of a hub assembly of an aquaculture system, according to an exemplary embodiment of the present disclosure;

FIG. 9 is a cross-section view taken along A-A of the aquaculture hub assembly of FIG. 8, according to an exemplary embodiment of the present disclosure;

FIG. 10 is a schematic diagram of radiating conduit connections of a hub assembly, according to an exemplary embodiment of the present disclosure; and

FIG. 11 is a schematic diagram of eccentric conduit connections of a hub assembly, according to another exemplary embodiment of the present disclosure.

### DETAILED DESCRIPTION

Various embodiments of the disclosure are discussed in details below. While specific implementations are discussed, it should be understood that this is done for illustration purposes only. A person skilled in the relevant art will recognize that other components and configurations may be used without parting from the spirit and scope of the disclosure. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is drawn to an aquaculture system having a negative, adjustable buoyancy enclosure operable to be disposed within a body of water. The system can have a mooring line extending between a first anchor and a second anchor, with each of the first anchor and the second anchor coupled to a bottom surface of the bottom of water. The mooring line can be further coupled with two buoys disposed within the body of water and positioned on opposing sides of the enclosure. The mooring line can extend between a first buoy and a second buoy and back to the bottom surface of the body of water at one of the first anchor and/or the second anchor. The mooring line can couple to and extend along at least a portion of a bottom surface of the enclosure between the first buoy and the second buoy.

The mooring line can be operable to control a depth within the body of water of the negatively buoyant enclosure, allowing the enclosure to be submerged within a water column of the body of water or substantially float at a surface of the body of water at a predetermined depth as desired by an operator. The mooring line can support at least a portion of the weight of the enclosure while allowing high fidelity control of submersion depth of the enclosure.

The mooring line and anchoring system of the present disclosure can be modular to allow for adjustment of the enclosure within the water column to maintain a desired predetermined depth without risking over submersion and/or uneven submersion including during strong current conditions. Strong current conditions, whether from surface wind and/or water currents, can cause uneven distribution of the enclosure within the water column causing injury and/or loss of the aquatic life within the enclosure.

The present disclosure can also include a central hub assembly implementable with the mooring and anchoring system. The central hub assembly can have a central body with a plurality of side walls, a top surface, and a bottom surface defining a ballast chamber. A plurality of apertures formed in the plurality of side walls allowing fluidic communication with the ballast chamber. A pneumatic valve can be coupled with each of the plurality of apertures operable to regulate fluidic communication with the ballast chamber. The ballast chamber is operable to receive water and/or air therein to adjust the relative buoyancy of the enclosure. In at least one instance, the pneumatic valve can be allow air to be added to the ballast chamber, thereby displacing any water from the ballast chamber and increasing the buoyance of the enclosure, thus reducing the depth of the enclosure in the water column. In other instances, the pneumatic valve and/or a vent can allow water to be added to be ballast chamber thereby displacing air from the ballast chamber and decreasing the buoyancy, thus increasing the depth of the enclosure in the water column. The mooring line coupled with a bottom surface of the enclosure can prevent lowering the enclosure too far into the water column and/or to the bottom surface of the body of water.

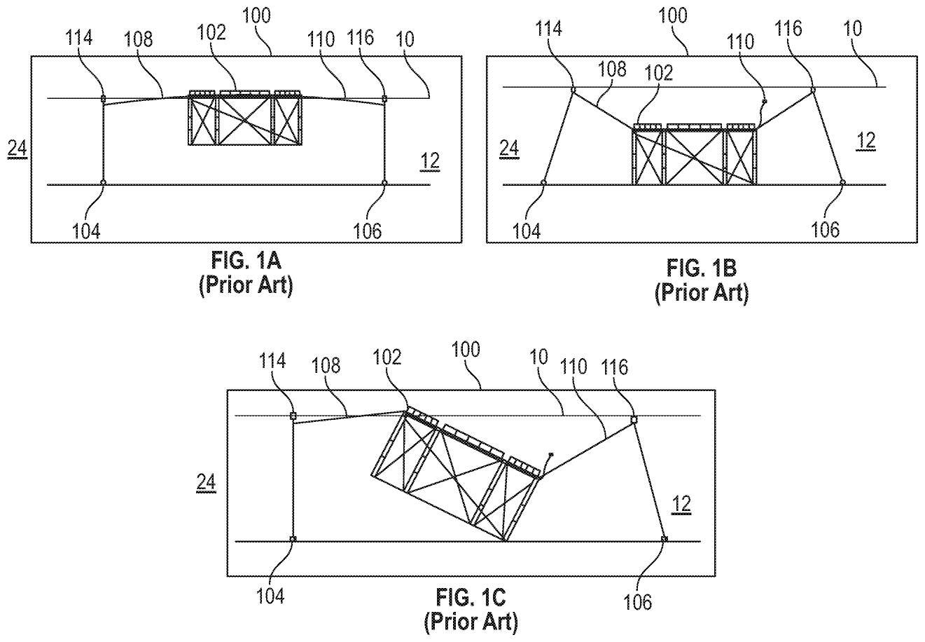

FIG. 1A illustrates a mooring and anchoring system technology as known in the field. The mooring and anchoring system 100 includes an enclosure 102 substantially floating on a surface 10 of a body of water 12. The enclosure 102 is disposed within the body of water 12 and secured by two anchors 104, 106 and two mooring lines 108, 110. The mooring lines 108, 110 are coupled to a top surface 112 of the enclosure 102 and are maintained near the surface 10 of the body of water 12 by two buoys 114, 116. The enclosure 102 attempts to maintain neutral buoyance within the body of water 12 to prevent extremely floating or extreme sinking.

As illustrated in FIGS. 1B and 1C, the depth of the enclosure 102 within the body of water 12 can be adjusted within the body of water 12. FIG. 1B illustrates the prior art mooring and anchoring system in a submerged position. The mooring lines 108, 110 allow the enclosure 102 to be lowered within the body of water 12; however, as can be appreciated by FIG. 1B the enclosure 102 risks being lowered too far and impacting the bottom of the body of water 12. Impacting the bottom, or increasing the depth too much, can damage the enclosure 102 or the aquatic life being grown within the enclosure 102. The ability of the enclosure 102 to achieve and/or maintain neutral buoyance within the body of water 12 is nearly impossible often resulting in damage to the enclosure 102 or the aquatic life.

FIG. 1C illustrates the prior art mooring and anchoring system in a partial submerged position. Due to inability to accurately control and/or maintain neutral buoyancy, the enclosure 102 can submerge partially and/or unevenly. The partial and/or uneven submersion of the enclosure 102 can result in damage to the enclosure 102 and/or the aquatic life therein.

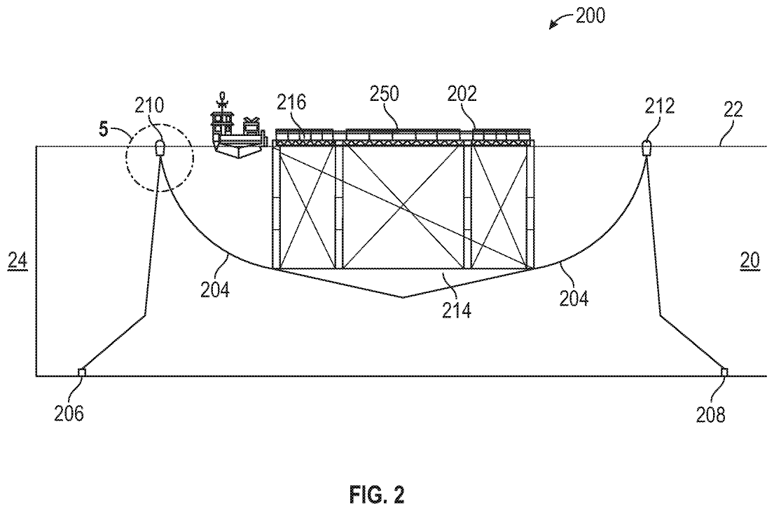

FIG. 2 illustrates a mooring and anchoring system according to at least one instance of the present disclosure. The mooring and anchoring system 200 can include an enclosure 202 disposed within a body of water 20. The enclosure 202 can be operable to float substantially on a surface 22 of the body of water 20 and/or be submerged within at least a portion of a water column 24 of the body of water 20.

The enclosure 202 can have a designed negative buoyancy and the mooring and anchoring system 200 can be implemented to maintain a predetermined position (e.g. depth) within the water column 24 to prevent excessive depth, and/or uneven submersion.

The mooring and anchoring system 200 can include a mooring line 204 disposed between two anchors 206, 208 disposed on opposing sides of the enclosure 202. The mooring line 204 can be coupled with two buoys 210, 212 substantially above the two anchors 206, 208, respectively. The mooring line 204 can couple with a bottom surface 214 of the enclosure 202 to assist in controlling depth of the enclosure 202 in the water column 24. The mooring line 204 being coupled with the bottom surface 214 can allow the buoys 210, 212 to provide known, even positive buoyancy to the mooring and anchoring system 200, while also supporting at least a portion of the weight of the enclosure 202.

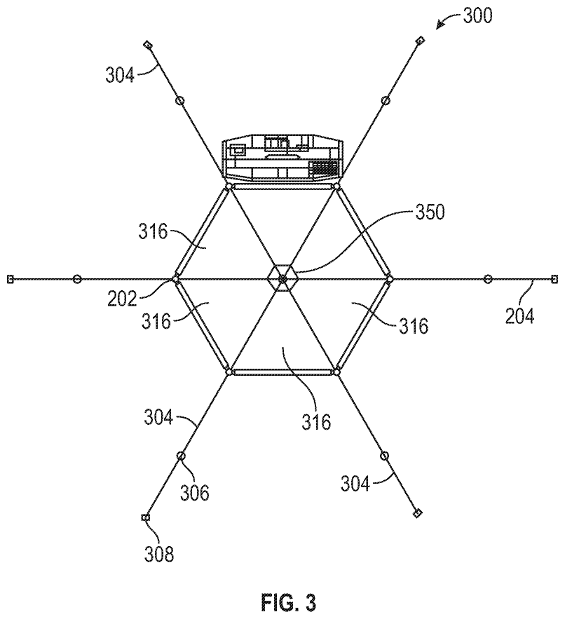

In some instances, the enclosure 202 can be separated into one or more spars 216 (shown more clearly in FIG. 3). The one or more spars 216 can be substantially even sub-compartments within the enclosure allowing multiple species and/or life-cycle stages of aquatic life to be within the enclosure 202 simultaneously. In some instances, the one or more spars 216 can have individually adjustable buoyance.

The arrangement of the enclosure 202 and spars 216 can determine the appropriate number of buoys 206, 208 and/or mooring lines 204 for the mooring and anchoring system 200. The mooring and anchoring system 200 can implement any number of buoys and/or mooring lines depending on the arrangement of the enclosure 202 to ensure proper buoyancy control and to prevent tilting and/or uneven submersion or raising of the enclosure within the water column.

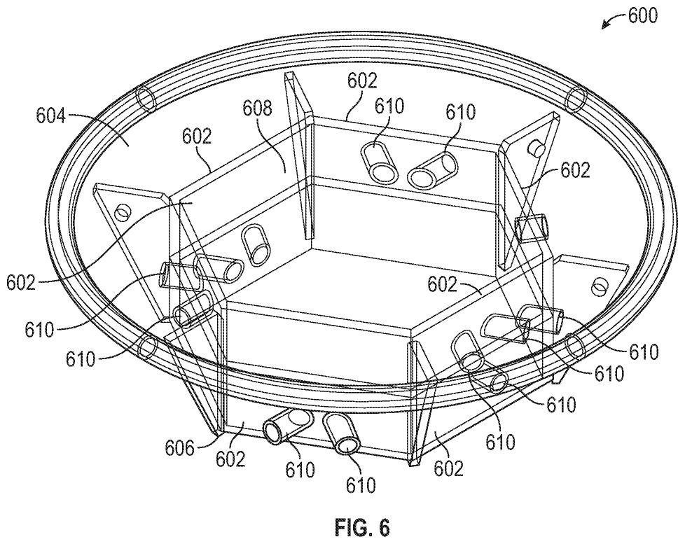

The enclosure 202 can include a central hub 250 operable to adjust the buoyancy of the enclosure 202, thus adjusting the depth of the enclosure 202 within the water column 24. The central hub 250, discussed in more detail with respect to FIGS. 6-9, can provide buoyancy control within the enclosure 202. The buoyancy control of the enclosure 202 can work in conjunction with the mooring line 204 to maintain depth within the water column 24 of the enclosure 202. In at least one instance, the central hub 250 can be operable to receive water and/or air within a ballast chamber, thus controlling the buoyancy of the enclosure 202. The central hub 250 can be operable to receive water to increase the negative buoyancy of the enclosure 202, thus lowering within the water column 24. The central hub 250 can be operable to receive water to reduce the negative buoyancy of the enclosure, thus rising within the water column 24.

FIG. 3 is a top view of an aquaculture mooring and anchoring system according to at least one instance of the present disclosure. The enclosure 302 can be substantially hexagonal shaped in lateral direction (as seen from above). The substantially hexagonal shape can allow the enclosure to evenly be divided into six (6) spars 314. While the present disclosure illustrates and describes an enclosure 302 being substantially hexagonal in the lateral direction and having six (6) spars 314, it is within the scope of this disclosure to implement an enclosure of any shape including, but not limited to, substantially circular, substantially square, substantially rectangular, etc. and implement any number of spars within the respective shape including, but not limited to, one, two, three, four, etc.

As can be appreciated in FIG. 3, the mooring and anchoring system 300 includes a plurality of mooring lines 304 coupled with the enclosure 302. The mooring lines 304 pass along the bottom surface 314 of the enclosure pass substantially through a middle point 318 of the enclosure 302. The mooring and anchoring system 300 can allow adjustment of the depth within the water column 24 of the enclosure 302. The plurality of mooring lines 304 can be synchronously and individually adjusted to change the position of the enclosure within the water column 24. Each of the plurality of mooring lines 304 can have a buoy 306 coupled therewith and be secured to the bottom of the body of water 12 at an anchor 308.

The enclosure 302 can further include a central hub 350, discussed in more detail with respect to FIGS. 6-9, providing buoyancy control of the enclosure 302. The buoyancy control provided by the central hub 350 can implemented in conjunction with, and/or independent of, the plurality of mooring lines 304 to adjust the position of the enclosure 302 within the water column.

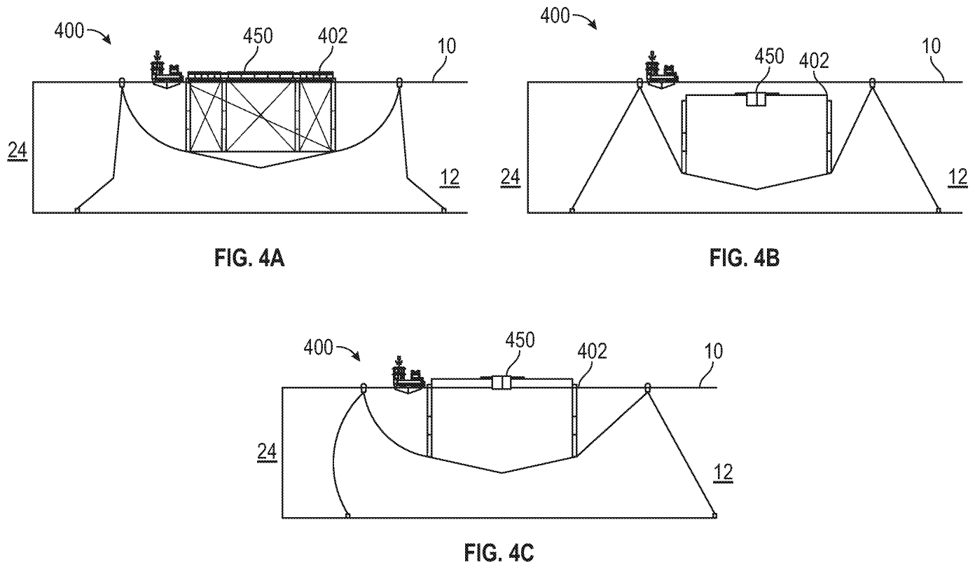

FIG. 4A illustrates a mooring and anchoring system positioned at the surface, according to at least one instance of the present disclosure. The mooring and anchoring system 400 can allow the enclosure 402 to float substantially at the surface 10 of the body of water 12. The enclosure 402 can be negatively buoyant and held in a substantially floating position by a plurality of mooring lines 404 and buoys 406 and/or a central hub 450 having the appropriate ballast to maintain a substantially floating position for the enclosure 402.

FIG. 4B illustrates a mooring and anchoring system positioned at a predetermined depth within the water column, according to at least one instance of the present disclosure. The mooring and anchoring system 400 can allow the enclosure 402 to submerge to a predetermined depth within the water column 24 of the body of water 12. The enclosure 402 can be negatively buoyant and held in the predetermined depth position by the plurality of mooring lines 404 and buoys 406 and/or the central hub 450 having the appropriate ballast to maintain the predetermined depth position for the enclosure 402.

FIG. 4C illustrates a mooring and anchoring system positioned at the surface in a strong current, according to at least one instance of the present disclosure. The mooring and anchoring system 400 can allow the enclosure 402 to float substantially at the surface 10 of the body of water 12 even during exposure to a significant current. The current can be a water current, a wind current, and/or a combination thereof. The enclosure 402 can be negatively buoyant and held in a substantially floating position by a plurality of mooring lines 404 and buoys 406 and/or a central hub 450 having the appropriate ballast to maintain a substantially floating position for the enclosure 402. The mooring lines 404 can further allow the enclosure 402 to drift into the current a predetermined amount before tensioning at least one of the plurality of mooring lines 404, thereby securing the enclosure 402 in the substantially floating position despite the exposed current.

As can be appreciated in FIGS. 4A-4C detailing multiple positions of the mooring and anchoring system 400, the mooring lines 404 are position within the body of water 12 and away from the surface 10, thus protecting the mooring lines 404 from the environmental elements including ice and waves and marine vessels 26, such as operators.

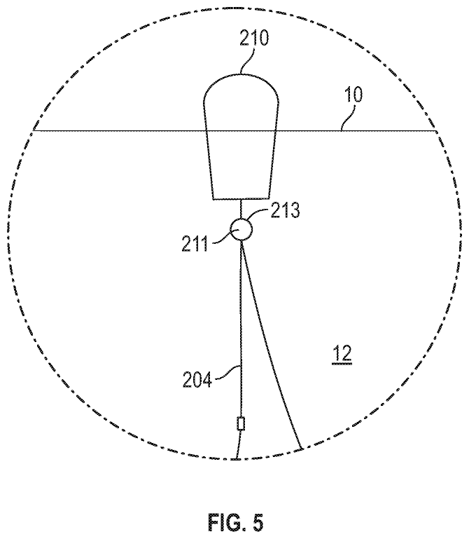

FIG. 5 illustrates a detailed view of a buoy, according to at least one instance of the present disclosure. The buoy 210 can have a positive buoyancy maintaining a position substantially on the surface 10 of the body of water 12. The buoy 210 can be coupled with the mooring link 204 view adjustable and/or replacement links, thus allowing the overall length and/or position of the mooring line 204 the changed. The buoy 210 can also act as a pivot point for the mooring line 204 during drift from currents and/or submerging of an enclosure. The buoy 210 can have a plate 211 having a plurality of apertures 213 formed therein. The mooring line 204 can be coupled with the plate 211 and/or at least one of the plurality of apertures 213. The coupling between the plate 211, plurality of apertures 213, and the mooring line 204 can change the overall length of the mooring line 204, thus altering the overall buoyancy of the mooring and anchoring system 200.

While FIG. 5 is described specifically with respect to buoy 210, the mooring and anchoring system of the present disclosure can implement a buoy as shown in FIG. 5 in a plurality of locations and in coordination with a plurality of mooring lines.

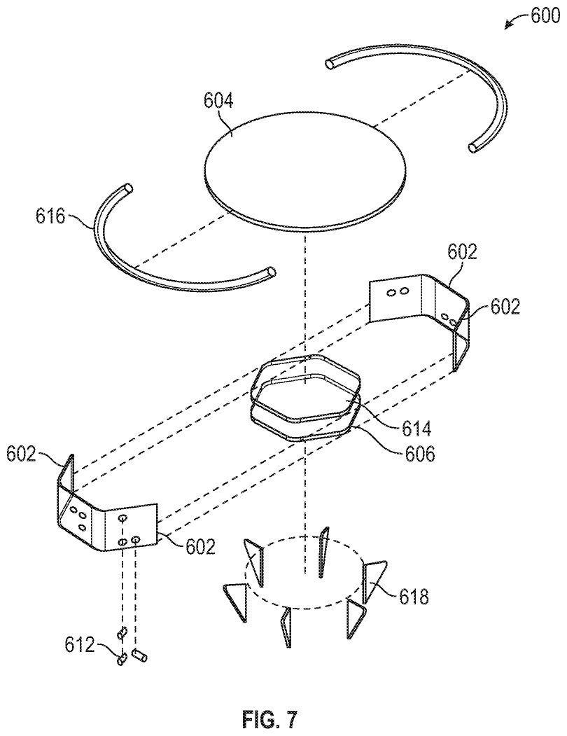

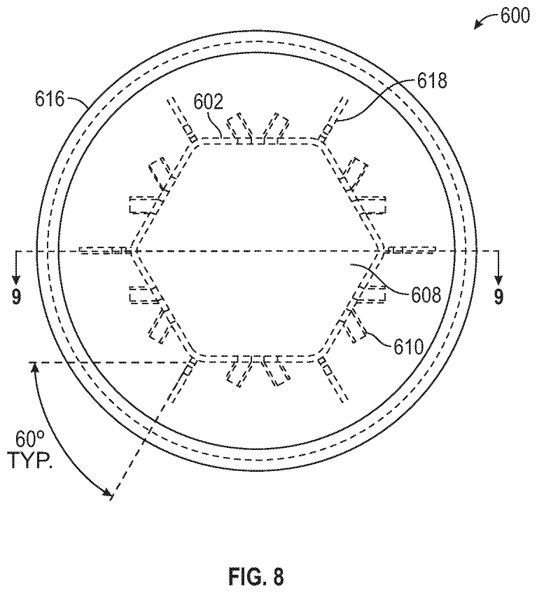

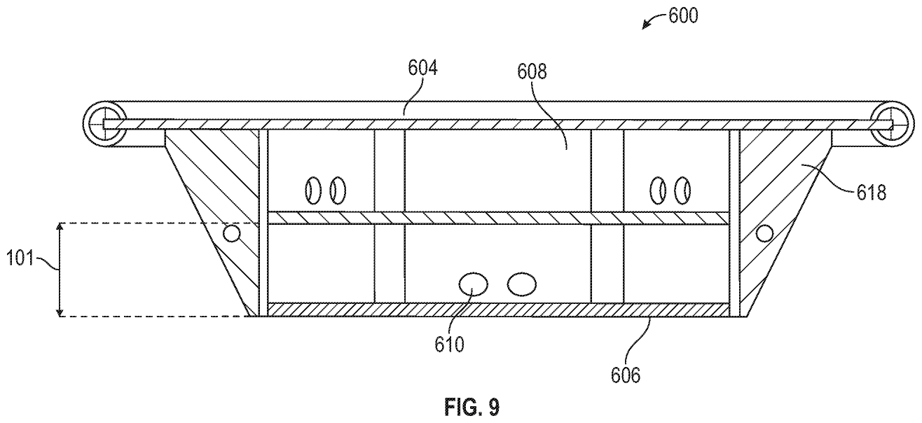

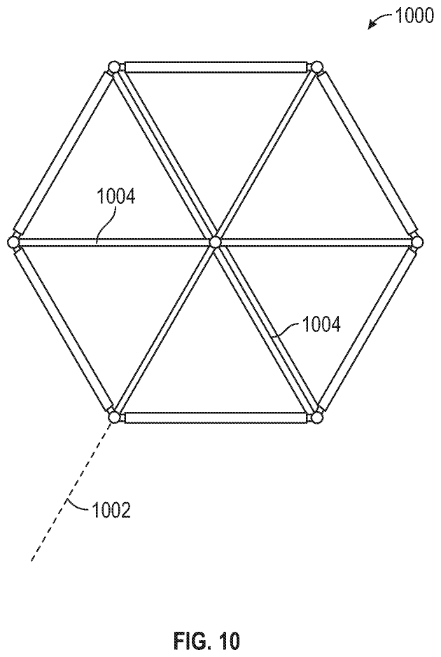

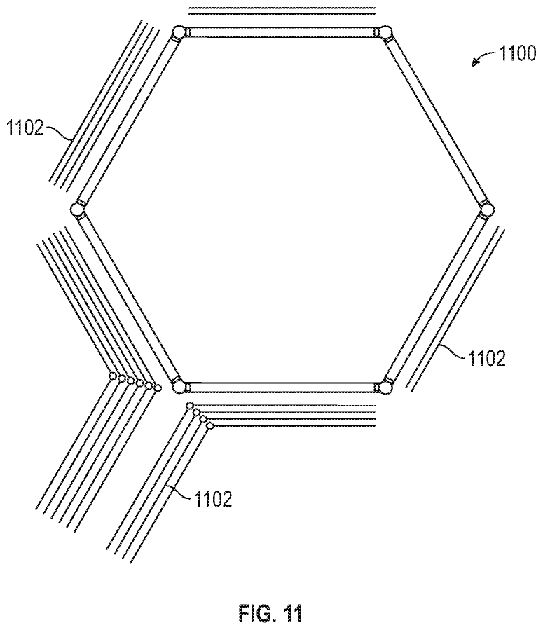

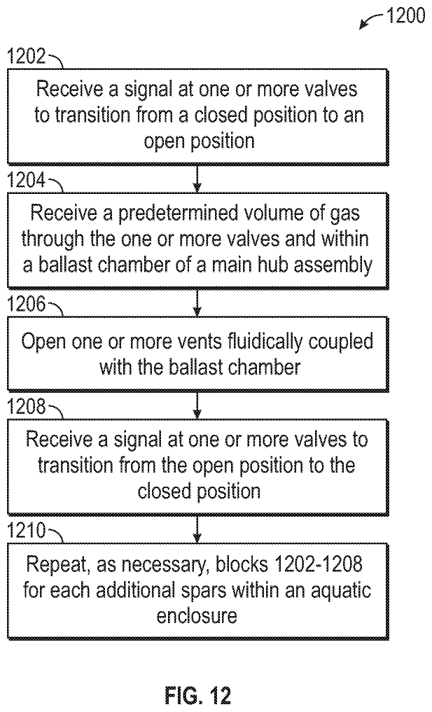

FIG. 6 illustrates a central hub assembly, according to at least one instance of the present disclosure. FIG. 7 illustrates an exploded view of the central hub assembly, according to at least one instance of the present disclosure. FIG. 8 illustrates a top view of the central hub assembly, according to at least one instance of the present disclosure. FIG. 9 illustrates a cross-section view of the central hub assembly, according to at least one instance of the present disclosure. The central hub assembly 600 can be coupled with an aquaculture enclosure and operably to adjust ballast and/or buoyancy of the enclosure in conjunction with the mooring and anchoring system, as described with respect to FIGS. 1-5. The central hub assembly 600 can have a plurality of side walls 602, an upper surface 604, and a bottom surface 606 defining a ballast chamber 608. The ballast chamber 608 can be operable to receive air and/or water therein, thereby adjusting the buoyancy of the central hub 600 and the aquaculture enclosure.

The plurality of side walls 602 can have a plurality of apertures 610 formed therein operable to provide fluidic communication into the ballast chamber 608. The plurality of apertures 610 can include a valve 612 coupled thereto operable to control fluidic communication between the ballast chamber 608 and a body of water disposed around the central hub 600. In at least one instance, the valve 612 can be a pneumatic valve regulating air inflow into the ballast chamber 608. The valve 612 can also be a mechanically controlled valve (e.g. linear actuation, etc.) to allow water from the body of water 20 to enter the ballast chamber 608 and/or allow air to be expelled from the ballast chamber 608 into the body of water 20.

The ballast chamber 608 can be operable to receive water and/or air therein to control the buoyancy of the central hub and/or an aquaculture enclosure. The plurality of apertures 610 and valves 612 can allow fluidic communication with the ballast chamber 608 to introduce water and/or air depending on the desired buoyancy change. The ballast chamber 608 can be operable to receive water to increase the negative buoyancy and be operable to receive air to increase the positive buoyancy.

As can be appreciated in FIGS. 7 and 9, the ballast chamber 608 can have a divider 614 separating the ballast chamber 608 into two or more compartments. The two compartments can be operable to receive water and/or air, respectively. A portion of the plurality of apertures 610 can be in fluidic communication with one compartment of the ballast chamber 608, and the remaining portion of the plurality of apertures 610 can be in fluidic communication with the other compartment of the ballast chamber 608. In other instances, the ballast chamber 608 can be a singular chamber wherein increasing the buoyancy of the central hub assembly 600 involves introducing air, or adding air, though at least one of the plurality of apertures 610 while water is displaced through one or more of the plurality of apertures 610. The central hub assembly 600 can also having the buoyancy decreased by adding water to the ballast chamber 608 through at least one of the plurality of apertures 610. The addition of water into the ballast chamber 608 can displace air from the ballast chamber 608 through one or more of the plurality of apertures 610.

The hub assembly 600 can include a cap 616 and one or more gussets 618 for structural integrity. The hub assembly 600 can have a cap 616 that is formed in two pieces, but is substantially circular (as shown in FIG. 7), and six (6) gussets 618 to support a six (6) spar structure as shown in the enclosure of FIG. 3. While the present disclosure details a substantially hexagonal hub assembly 600, the hub assembly 600 can be formed in any shape and/or arrangement and in at least some instances the hub assembly 600 can be shaped to correspond to the enclosure.

In at least one instance, the plurality of apertures 610 can be bi-directional apertures allowing water and/or air to be added and/or removed from the ballast chamber 608. In other instances, a portion of the plurality of apertures 610 can be inlets and a portion of the plurality of apertures 610 can be exhausts operable to introduce and release air and/or water, respectively. In other instances, a portion of the plurality of apertures 610 can be bi-directional for one of air and water and the remaining portion of the plurality of apertures 610 can be bi-directional for the other of air and water. In yet other instances, a portion of the plurality of apertures 610 can be water inlets, a portion of the plurality apertures 610 can be air inlets, and a portion of the apertures 610 can be water outlets, and a portion of the plurality of apertures 610 can be air outlets. Additionally in yet other instances, a portion of the plurality of apertures 610 can be water inlets, a portion of the plurality apertures 610 can be air inlets, and a portion of the apertures 610 can be outlets for air and/or water.

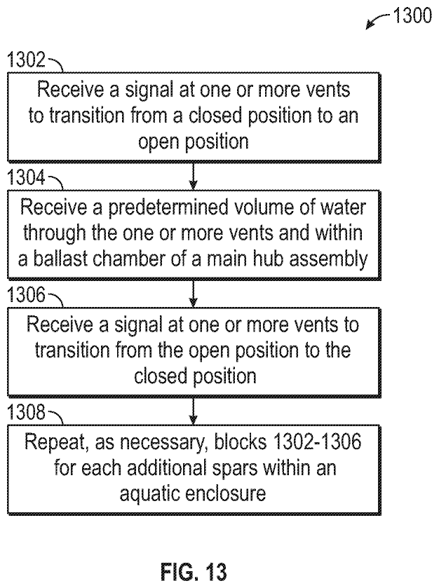

FIG. 10 illustrates a concentric piping structure for the central hub assembly, according to at least one instance of the present disclosure. The central hub assembly 600 can have a supply line structure 1000 operable to provide air to the ballast chamber 608. The supply line structure 1000 can be coupled to one or more of the plurality of apertures 610 and valves 612. The supply line structure 1000 can include a main supply line 1002 and a plurality of feeder supply lines 1004. In at least one instance, each of the plurality of feeder supply lines 1004 can couple with an one spar of the enclosure and corresponding main hub assembly.

FIG. 11 illustrates an eccentric piping structure for the central hub assembly, according to at least one instance of the present disclosure. The central hub assembly 600 can have a supply line structure 1100 operable to provide air to the ballast chamber 608. The supply line structure 1100 can be coupled to one or more of the plurality of apertures 610 and valves 612. The supply line structure 1100 can a plurality of feeder supply lines 1102 running in parallel to the respective aperture 610 and/or valve 612 for coupling. In at least one instance, each of the plurality of feeder supply lines 1102 can couple with an one spar of the enclosure and corresponding main hub assembly.

The main hub assembly and/or a supply line structure can be implemented with any commercially available spar enclosure to at least partially control the buoyancy of the enclosure. The mooring and anchoring system disclosed herein can similarly be implemented with any commercially available spar enclosure individually and/or in combination with a main hub assembly. Further, the mooring and anchoring system, main hub assembly, and spar enclosure can be collectively sold in any combination desired by user.

Referring to FIG. 12, a flowchart is presented in accordance with an example method. The example method 1200 is provided by way of example, as there is a variety of ways to carry out the method 1200. Each block shown in FIG. 12 represents one or more processes, methods, or subroutines, carried out in the example method 1200. Furthermore, the illustrated order of blocks is illustrative only and the order of the blocks can change according to the present disclosure. Additional blocks may be added or fewer blocks can be utilized, without deviating from the present disclosure. The example method 1200 can begin at block 1202.

At block 1202, one or more valves coupled with a supply line can receive a signal to transition from a closed position to an open position. The one or more valves can be coupled with a main hub assembly of an aquatic enclosure and provide fluidic communication with a ballast chamber of the main hub assembly. Operation of the one or more valves can be by a pneumatic, hydraulic, or other signal.

At block 1204, a predetermined volume of gas (e.g. air) can be received within the ballast chamber of a main hub assembly. The predetermined volume of gas can be determined based on change in ballast and a desired height change of the main assembly and/or the aquatic enclosure. The gas supplied by the supply line can be atmospheric air or any other gas (e.g. Nitrogen, Helium, and/or any mixture of gases), and the predetermined volume of air can be based at least in part on the supplied gas.

At block 1206, one or more vents fluidicly coupled with the ballast chamber of the main hub assembly can open to allow at least a portion of the contents of the ballast chamber to be displaced by the predetermined volume of gas. The one or more vents can be transitionable between an open and closed state and/or be a one-way valve(s) operable to allow displaced contents to escape without allowing environmental elements to enter the ballast chamber.

At block 1208, the one or more valves can receive a signal to transition from the open position to the closed position. The one or more valves in the closed position and fluidicily decouple the ballast chamber of the main hub assembly and the supply line, thus terminating gas flow from the supply line to the ballast chamber. The one or more valves can receive a signal to transition from open to closed after a predetermined time and/or after a predetermined volume of gas. In at least one instance, the predetermined time can be based at least in part on the pressure and/or flow rate of gas within the supply line.

At block 1210, blocks 1202-1208 can be repeated as necessary for each of the one or more spars of the aquatic enclosure. In at least one instance, blocks 1202-1208 can be performed simultaneously for each of the one or more spars to evenly raise the aquatic culture. In other instances, the blocks 1202-1208 can be performed in a predetermined pattern (e.g. opposing spars, caddy-corner, etc.) to ensure even and/or level raising of the aquatic enclosure.

Referring to FIG. 13, a flowchart is presented in accordance with an example method. The example method 1300 is provided by way of example, as there is a variety of ways to carry out the method 1300. Each block shown in FIG. 13 represents one or more processes, methods, or subroutines, carried out in the example method 1300. Furthermore, the illustrated order of blocks is illustrative only and the order of the blocks can change according to the present disclosure. Additional blocks may be added or fewer blocks can be utilized, without deviating from the present disclosure. The example method 1300 can begin at block 1302.

At block 1302, one or more vents fluidicily coupled with a ballast chamber of a main hub assembly can be transitioned from a closed position to an open position. The one or more vents can provide fluidic communication between the ballast chamber and an adjacent aquatic enclosure. The one or more vents can allow the ballast chamber to release gas into the adjacent environment and thus reducing the overall buoyancy of the main hub assembly (and related aquatic enclosure).

At block 1304, the ballast chamber can receive a predetermined volume of water from the adjacent aquatic environment. The predetermined volume of water can be related to the amount of gas to be expelled, the overall desired reduction in buoyancy, and/or aquatic enclo sure.

At block 1306, the one or more vents can be transitioned from the open position to the closed position. After receiving the predetermined volume of water from the adjacent environment, the one or more vents can transition to the closed positon, thus achieving the desired reduction in buoyancy.

At block 1308, blocks 1302-1306 can be repeated as necessary for each of the one or more spars of the aquatic enclosure. In at least one instance, blocks 1302-1306 can be performed simultaneously for each of the one or more spars to evenly lower the aquatic enclosure within the water column. In other instances, the blocks 1302-1306 can be performed in a predetermined pattern (e.g. opposing spars, caddy-corner, etc.) to ensure even and/or level lowering of the aquatic enclosure.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

Statement of the Claims

Statement 1: An aquaculture system comprising: a negatively buoyant enclosure, the enclosure operable to be disposed within a body of water; a mooring line extending between a first anchor and a second anchor, the first anchor and the second anchor operable to be coupled to a bottom surface of the body of water; two buoys disposed on opposing sides of the enclosure, wherein the mooring line extends from a first anchor to a first buoy and a second buoy and back to the second anchor, wherein the mooring line is coupled to a bottom surface of the enclosure between the first buoy and the second buoy.

Statement 2: The aquaculture system of Statement 1, wherein the mooring line is operable to control a predetermined depth of the enclosure within the body of water.

Statement 3: The aquaculture system of Statement 1 or Statement 2, wherein the mooring line supports at least a portion of the weight of the enclosure.

Statement 4: The aquaculture system of any one of Statements 1-3, wherein the enclosure is operable to transition between floating at a surface of the body of water and submerged a predetermined depth below the surface of the body of water.

Statement 5: The aquaculture system of any one of Statements 1-4, wherein the enclosure includes a central hub assembly having adjustable ballast operable to adjust a buoyancy of the enclosure.

Statement 6: The aquaculture system of any one of Statements 1-5, wherein the central hub assembly includes a ballast chamber operable to receive water and/or air, thereby altering the buoyancy of the enclosure.

Statement 7: The aquaculture system of any one of Statements 1-6, wherein the ballast chamber is coupled with one or more pneumatic valves operable to supply air into the ballast chamber.

Statement 8: The aquaculture system of any one of Statements 1-7, wherein the central hub assembly includes a plurality of ballast chambers, each of the plurality of ballast chambers operable to receive water and/or air, thereby altering the buoyancy of the enclosure.

Statement 9: The aquaculture system of any one of Statements 1-8, wherein each of the plurality of the ballast chambers is coupled with one or more pneumatic valves operable to supply air into the ballast chamber.

Statement 10: The aquaculture system of any one of Statements 1-9, wherein enclosure includes a plurality spars, each spar corresponding to at least one ballast chamber of the plurality of ballast chambers.

Statement 11: An aquaculture central hub assembly, comprising: a central body having a plurality of side walls, a top surface, and a bottom surface defining a ballast chamber; a plurality of apertures formed in the plurality of side walls, the plurality of apertures in fluidic communication with the ballast chamber; a valve coupled with each of the plurality of apertures, the valve operable to regulate fluidic communication with the ballast chamber, wherein the ballast chamber is operable to receive water and/or air therein.

Statement 12: The aquaculture central hub assembly of Statement 11, wherein the valve is a pneumatic valve operable to transition between a closed position and an open position.

Statement 13: The aquaculture central hub assembly of Statement 11 or Statement 12, further comprising a supply line coupled with the valve, the supply line operable to provide air to the ballast chamber.

Statement 14: The aquaculture central hub assembly of any one of Statements 11-13, wherein the ballast chamber has a plurality of chambers therein.

Statement 15: The aquaculture central hub assembly of any one of Statements 11-14, wherein each chamber of the plurality of chambers has at least one of the plurality of apertures coupled with the valve and is operable to receive water and/or air therein.

Statement 16: The aquaculture central hub assembly of any one of Statements 11-15, wherein each chamber of the plurality of chambers correspond to corresponds one a spar of an aquatic enclosure.

Statement 17: The aquaculture central hub assembly of any one of Statements 11-16, further comprising one or more vents in fluidic communication with the ballast chamber, the one or more vents operable to discharge water and/or air from the ballast chamber.

Statement 18. A method comprising: placing a negatively bouyant enclosure within a body of water, the enclosure having a central body with one or more ballast chambers and a plurality of supply lines coupled with the one or more ballast chambers, each of the plurality of supply lines having a valve coupled therewith; receiving a signal to actuate one or more valves coupled with the plurality of supply lines from a closed position to an open position; receiving, via the plurality of supply lines, a predetermined volume of gas into the one or more ballast chambers; opening one or more vents fluidicly coupled with the one or more ballast chambers, thereby allowing at least a portion of the contents of the one or more ballast chamber to be displaced by the predetermined volume of gas; receiving a signal to actuate one or more valves from the open position to the closed position, thus terminating gas flow from the supply line to the one or more ballast chamber.

Statement 19: The method of Statement 18, further comprising opening the one or more vents to displace the predetermined volume of gas.

Statement 20: The method of Statement 18 or Statement 19, wherein the one or more vents are one-way vents allowing at least a portion of the contents to be displaced from the one or more ballast chambers.

What is claimed is:

1. An aquaculture system comprising:
a negatively buoyant enclosure, the enclosure operable to be disposed within a body of water;
a mooring line extending between a first anchor and a second anchor, the first anchor and the second anchor operable to be coupled to a bottom surface of the body of water;
two buoys disposed on opposing sides of the enclosure, wherein the mooring line extends from a first anchor to a first buoy and a second buoy and back to the second anchor,
wherein the mooring line is coupled to a bottom surface of the enclosure between the first buoy and the second buoy.

2. The aquaculture system of claim 1, wherein the mooring line is operable to control a predetermined depth of the enclosure within the body of water.

3. The aquaculture system of claim 1, wherein the mooring line supports at least a portion of the weight of the enclosure.

4. The aquaculture system of claim 1, wherein the enclosure is operable to transition between floating at a surface of the body of water and submerged a predetermined depth below the surface of the body of water.

5. The aquaculture system of claim 1, wherein the enclosure includes a central hub assembly having adjustable ballast operable to adjust a buoyancy of the enclosure.

6. The aquaculture system of claim 5, wherein the central hub assembly includes a ballast chamber operable to receive water and/or air, thereby altering the buoyancy of the enclosure.

7. The aquaculture system of claim 6, wherein the ballast chamber is coupled with one or more pneumatic valves operable to supply air into the ballast chamber.

8. The aquaculture system of claim 5, wherein the central hub assembly includes a plurality of ballast chambers, each of the plurality of ballast chambers operable to receive water and/or air, thereby altering the buoyancy of the enclosure.

9. The aquaculture system of claim 8, wherein each of the plurality of the ballast chambers is coupled with one or more pneumatic valves operable to supply air into the ballast chamber.

10. The aquaculture system of claim 8, wherein enclosure includes a plurality spars, each spar corresponding to at least one ballast chamber of the plurality of ballast chambers.

11. An aquaculture central hub assembly, comprising:
a central body having a plurality of side walls, a top surface, and a bottom surface defining a ballast chamber;
a plurality of apertures formed in the plurality of side walls, the plurality of apertures in fluidic communication with the ballast chamber;
a valve coupled with each of the plurality of apertures, the valve operable to regulate fluidic communication with the ballast chamber,
wherein the ballast chamber is operable to receive water and/or air therein.

12. The aquaculture central hub assembly of claim 11, wherein the valve is a pneumatic valve operable to transition between a closed position and an open position.

13. The aquaculture central hub assembly of claim 11, further comprising a supply line coupled with the valve, the supply line operable to provide air to the ballast chamber.

14. The aquaculture central hub assembly of claim 11, wherein the ballast chamber has a plurality of chambers therein.

15. The aquaculture central hub assembly of claim 14, wherein each chamber of the plurality of chambers has at least one of the plurality of apertures coupled with the valve and is operable to receive water and/or air therein.

16. The aquaculture central hub assembly of claim 14, wherein each chamber of the plurality of chambers correspond to corresponds one a spar of an aquatic enclosure.

17. The aquaculture central hub assembly of claim 11, further comprising one or more vents in fluidic communication with the ballast chamber, the one or more vents operable to discharge water and/or air from the ballast chamber.

18. A method comprising:
placing a negatively bouyant enclosure within a body of water, the enclosure having a central body with one or more ballast chambers and a plurality of supply lines coupled with the one or more ballast chambers, each of the plurality of supply lines having a valve coupled therewith;
receiving a signal to actuate one or more valves coupled with the plurality of supply lines from a closed position to an open position;
receiving, via the plurality of supply lines, a predetermined volume of gas into the one or more ballast chambers;
opening one or more vents fluidicly coupled with the one or more ballast chambers, thereby allowing at least a portion of the contents of the one or more ballast chamber to be displaced by the predetermined volume of gas;
receiving a signal to actuate one or more valves from the open position to the closed position, thus terminating gas flow from the supply line to the one or more ballast chamber.

19. The method of claim 18, further comprising opening the one or more vents to displace the predetermined volume of gas.

20. The method of claim 18, wherein the one or more vents are one-way vents allowing at least a portion of the contents to be displaced from the one or more ballast chambers.
